(19) United States
(12) Patent Application Publication
(10) Pub. No.: US 2025/0364660 A1
(43) Pub. Date: Nov. 27, 2025

(54) BATTERY PACK AND METHOD FOR MANUFACTURING CELL STACK

(71) Applicants: HYUNDAI MOTOR COMPANY, SEOUL (KR); KIA CORPORATION, SEOUL (KR)

(72) Inventors: Kyung Mo KIM, Hwaseong-si (KR); Jong Gyu PARK, Hwaseong-si (KR); Gun Woo KO, Hwaseong-si (KR); Chan Sol KIM, Hwaseong-si (KR)

(21) Appl. No.: 18/962,677

(22) Filed: Nov. 27, 2024

(30) Foreign Application Priority Data
May 24, 2024 (KR) 10-2024-0068049

(51) Int. Cl. H01M 50/244; H01M 50/264; H01M 50/289; H01M 50/367; H01M 50/507; H01M 50/528; H01M 50/591

(52) U.S. Cl. CPC H01M 50/244; H01M 50/264; H01M 50/289; H01M 50/367; H01M 50/507; H01M 50/528; H01M 50/591

(57) ABSTRACT

Disclosed is a battery pack including a battery housing defining an accommodation space, and including a crossing member extending in a first direction to divide the accommodation space, a plurality of cell stacks mounted in the accommodation space to face each other in a second direction crossing the first direction with the crossing member being interposed therebetween, and a supporting frame supporting the plurality of cell stacks, and configured such that a portion thereof is rotatable with respect to another portion thereof. The crossing member includes a venting passage extending in the first direction between the plurality of cell stacks, and communicated with each of the plurality of cell stacks.

### CROSS-REFERENCE TO RELATED APPLICATION

This application claims the benefit of priority to Korean Patent Application No. 10-2024-0068049, filed in the Korean Intellectual Property Office on May 24, 2024, the entire contents of which are incorporated herein by reference.

### TECHNICAL FIELD

The present disclosure relates to a battery pack, and a method for manufacturing a cell stack.

### BACKGROUND

Recently, as awareness of the crisis regarding the environment and depletion of petroleum resources has increased, research and development on electric vehicles, which are eco-friendly vehicles, has been highlighted. Electric vehicles include a plug-in hybrid electric vehicle (PHEV), a battery electric vehicle (BEV), and a fuel cell electric vehicle (FCEV).

An electric vehicle may include a battery housing that supports battery cells. Meanwhile, an electric vehicle uses battery cells as a power source, and efforts have been made recently to increase the capacity of battery cells accommodated in an interior of the battery housing.

To improve the capacity of battery cells, battery cells may be accommodated in the interior of the battery housing in the form of cell to pack (CTP) rather than in the form of modules. Meanwhile, when the battery cells are mounted on the battery housing in the form of CTP, the battery cells may be mounted in the form of a cell stack. Then, a need for a structure, in which the lead part of the cell stack and a busbar are easily coupled to each other, is increasing.

### SUMMARY

The present disclosure has been made to solve the above-mentioned problems occurring in the prior art while advantages achieved by the prior art are maintained intact.

An aspect of the present disclosure provides a battery pack including a structure, in which a lead part of a cell stack and a busbar are easily coupled to each other, and a method for manufacturing a cell stack.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery pack includes a battery housing defining an accommodation space, and including a crossing member extending in a first direction to divide the accommodation space, a plurality of cell stacks mounted in the accommodation space to face each other in a second direction crossing the first direction with the crossing member being interposed therebetween, and a supporting frame supporting the plurality of cell stacks, and configured such that a portion of the supporting frame is rotatable with respect to another portion of the supporting frame, the crossing member includes a venting passage extending in the first direction between the plurality of cell stacks, and communicated with each of the plurality of cell stacks.

Each of the plurality of cell stacks may include a lead part protruding toward the crossing member, and the supporting frame may include a busbar electrically connected to the lead part, and a communication hole spaced apart from the busbar in the first direction while communicating the venting passage and the cell stack.

An area, in which the busbar and the lead part are connected to each other, and the communication hole may be alternately disposed along the first direction.

The crossing member may include a venting hole formed in an area facing the communication hole.

The battery housing may further include a base plate contacting the crossing member, the plurality of cell stacks include a plurality of first cell stacks disposed on one side of the base plate in a third direction crossing the first direction and the second direction, and a plurality of second cell stacks disposed on an opposite side of the base plate in the third direction, and the supporting frame may include a first supporting frame that support the plurality of first cell stacks, and a second supporting frame that support the plurality of second cell stacks.

The plurality of first cell stacks may include a (1-1)-th cell stack mounted on one side of the crossing member in the second direction, in the accommodation space, and a (1-2)-th cell stack mounted on an opposite side of the crossing member in the second direction, in the accommodation space, and the first supporting frame may include a (1-1)-th supporting frame area supporting the (1-1)-th cell stack, and a (1-2)-th supporting frame area supporting the (1-2)-th cell stack.

The (1-1)-th supporting frame area and the (1-2)-th supporting frame area may be coupled to each other to be rotatable with respect to each other.

Each of the (1-1)-th supporting frame area and the (1-2)-th supporting frame area may include an adhesion surface provided on an opposite side to one side, on which the crossing member of the (1-1)-th cell stack or the (1-2)-th cell stack is provided, and that fixes the (1-1)-th cell stack or the (1-2)-th cell stack.

The supporting frame may further include a busbar cover that covers an opposite side to one side of the busbar, which is connected to the lead part.

The busbar cover may be formed of an electrically insulating material.

The crossing member may include a first crossing member disposed on the base plate in the third direction, and a second crossing member disposed on an opposite side of the base plate in the third direction, the first crossing member may include a (1-1)-th crossing member, and a (1-2)-th crossing member spaced apart from the (1-1)-th crossing member in the second direction, the plurality of first cell stacks may include a (1-1)-th cell stack disposed on the one side of the (1-1)-th crossing member in the second direction, a (1-2)-th cell stack disposed on the opposite side of the (1-1)-th crossing member in the second direction, a (1-3)-th cell stack disposed on the one side of the (1-2)-th crossing member in the second direction, and a (1-4)-th cell stack disposed on the opposite side of the (1-2)-th crossing member in the second direction, and the first supporting frame may include a (1-1)-th supporting frame area supporting the (1-1)-th cell stack and the (1-4)-th cell stack together, a (1-2)-th supporting frame area supporting the (1-2)-th cell stack, and a (1-3)-th supporting frame area supporting the (1-3)-th cell stack.

Each of the (1-2)-th supporting frame area and the (1-3)-th supporting frame area may be coupled to be rotatable from the (1-1)-th supporting frame area.

Each of the (1-2)-th supporting frame area and the (1-3)-th supporting frame area may include an adhesion surface provided on an opposite side to one side, on which the crossing member of the (1-2)-th cell stack or the (1-3)-th cell stack is provided, and that fixes the (1-2)-th cell stack or the (1-3)-th cell stack.

The (1-1)-th supporting frame area may include an adhesion surface disposed between the (1-1)-th cell stack and the (1-4)-th cell stack, and that fixes the (1-1)-th cell stack or the (1-4)-th cell stack.

According to another aspect of the present disclosure, a method for manufacturing a cell stack includes a preparing operation of preparing a supporting frame, at least a portion of which is rotatable about a central axis extending in a first direction, an applicating operation of applying an adhesive on one surface of the supporting frame to fix a cell stack to the one surface, and an assembling operation of assembling the cell stack in the supporting frame.

The cell stack may include a first cell stack and a second cell stack, the first cell stack may include a (1-1)-th cell stack, and a (1-2)-th cell stack spaced apart from the (1-1)-th cell stack in a horizontal direction, the supporting frame may include a first supporting frame and a second supporting frame, the first supporting frame include a (1-1)-th supporting frame area supporting the (1-1)-th cell stack, and a (1-2)-th supporting frame area supporting the (1-2)-th cell stack, and the (1-1)-th supporting frame area and the (1-2)-th supporting frame area may be coupled to each other to be rotatable about the central axis.

The assembling operation may include welding a lead part of the (1-1)-th cell stack or the (1-2)-th cell stack and a busbar in an area being adjacent to the central axis in a state, in which the (1-1)-th supporting frame area and the (1-2)-th supporting frame area are rotated to have a specific angle.

The method may further include a cover assembling operation of assembling a busbar cover on an opposite side to one side of the busbar, which is connected to the lead part.

The method may further include a mounting preparing operation of, unfolding the supporting frame by rotating the (1-1)-th supporting frame area and the (1-2)-th supporting frame area about the central axis, after the cover assembling operation.

### BRIEF DESCRIPTION OF THE DRAWINGS

The above and other objects, features and advantages of the present disclosure will be more apparent from the following detailed description taken in conjunction with the accompanying drawings:

FIG. 1 is an exploded perspective view of a battery pack according to an embodiment of the present disclosure;

FIG. 2 is a vertical cross-sectional view of a battery pack according to an embodiment of the present disclosure;

FIG. 3 is a schematic view sequentially illustrating a state in which a first cell stack and a second cell stack are mounted on a battery housing according to an embodiment of the present disclosure;

FIG. 4 is a schematic view sequentially illustrating a state in which a first cell stack and a second cell stack are mounted on a battery housing according to an embodiment of the present disclosure;

FIG. 5 is a schematic view sequentially illustrating a state in which a first cell stack and a second cell stack are mounted on a battery housing according to an embodiment of the present disclosure;

FIG. 6 is a schematic view sequentially illustrating a state in which a first cell stack and a second cell stack are mounted on a battery housing according to an embodiment of the present disclosure;

FIG. 7 is a schematic view sequentially illustrating a state in which a first cell stack and a second cell stack are mounted on a battery housing according to an embodiment of the present disclosure;

FIG. 8 is a schematic view illustrating a flame or gas that flows through a venting passage when a fire occurs in cell stacks that face each other with a crossing member being interposed therebetween according to an embodiment of the present disclosure;

FIG. 9 is an enlarged view of a venting device that is mounted on a battery housing according to an embodiment of the present disclosure;

FIG. 10A is a perspective view of a first cell stack that is mounted on a first supporting frame according to an embodiment of the present disclosure;

FIG. 10B is a perspective view of a second cell stack that is mounted on a second supporting frame according to an embodiment of the present disclosure;

FIG. 11 is a perspective view sequentially illustrating a process of manufacturing a second cell stack according to an embodiment of the present disclosure;

FIG. 12 is a perspective view sequentially illustrating a process of manufacturing a second cell stack according to an embodiment of the present disclosure;

FIG. 13 is a perspective view sequentially illustrating a process of manufacturing a second cell stack according to an embodiment of the present disclosure;

FIG. 14 is a perspective view sequentially illustrating a process of manufacturing a second cell stack according to an embodiment of the present disclosure;

FIG. 15 is a perspective view sequentially illustrating a process of manufacturing a second cell stack according to an embodiment of the present disclosure;

FIG. 16 is a perspective view sequentially illustrating a process of manufacturing a second cell stack according to an embodiment of the present disclosure;

FIG. 17 is a perspective view sequentially illustrating a process of manufacturing a second cell stack according to an embodiment of the present disclosure; and

FIG. 18 is a flowchart of a method for manufacturing a cell stack according to an embodiment of the present disclosure.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

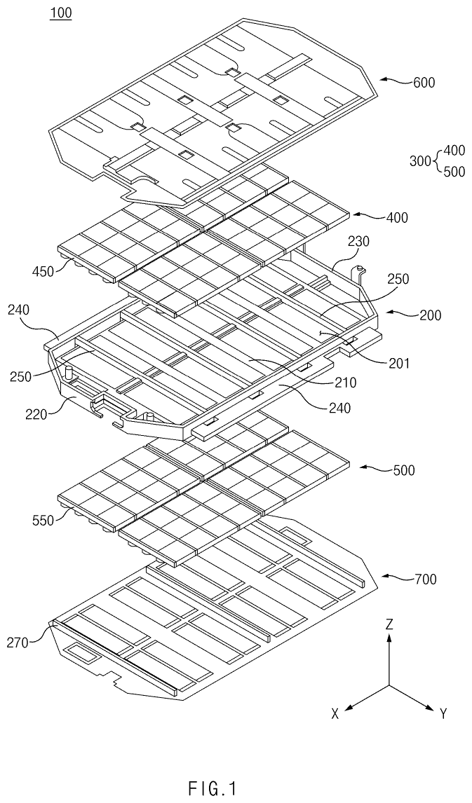

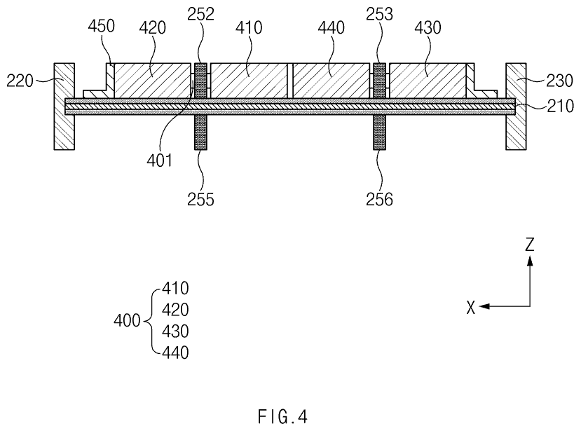

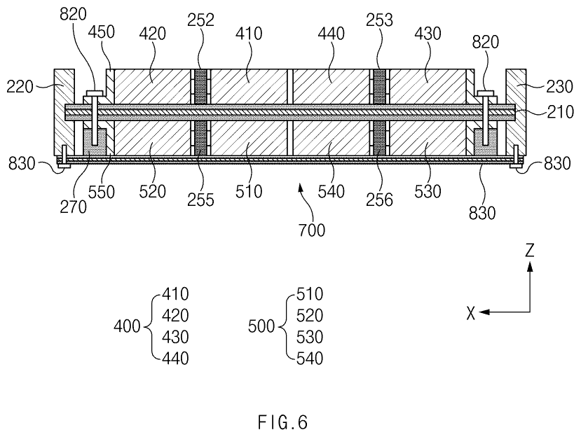

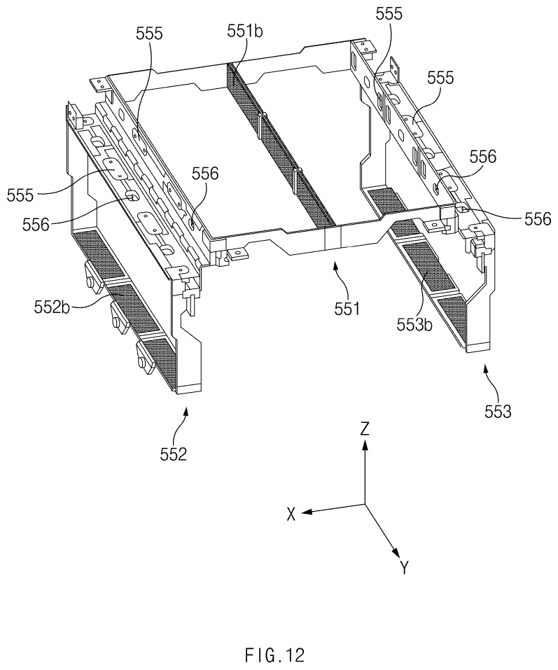

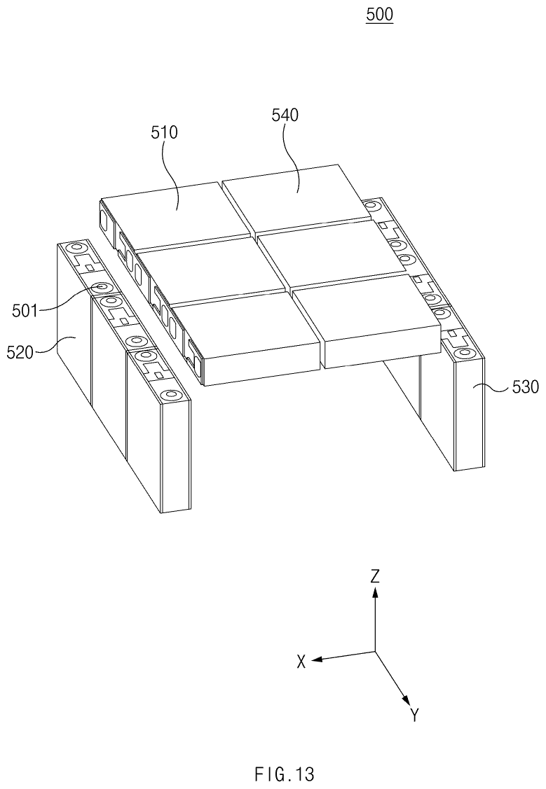

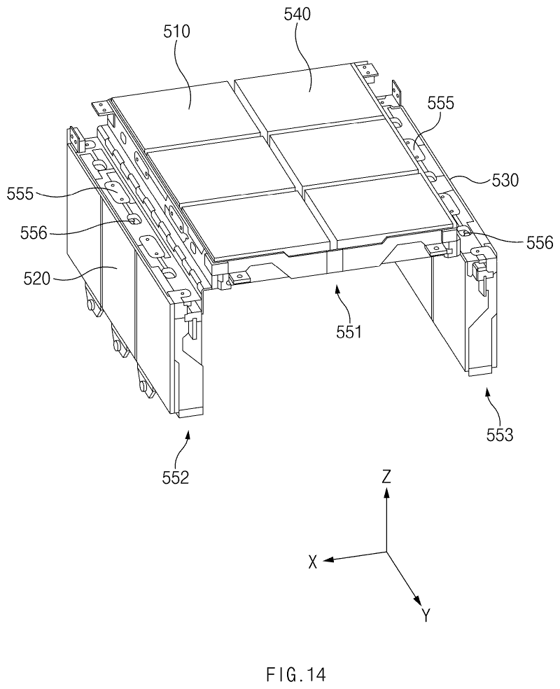

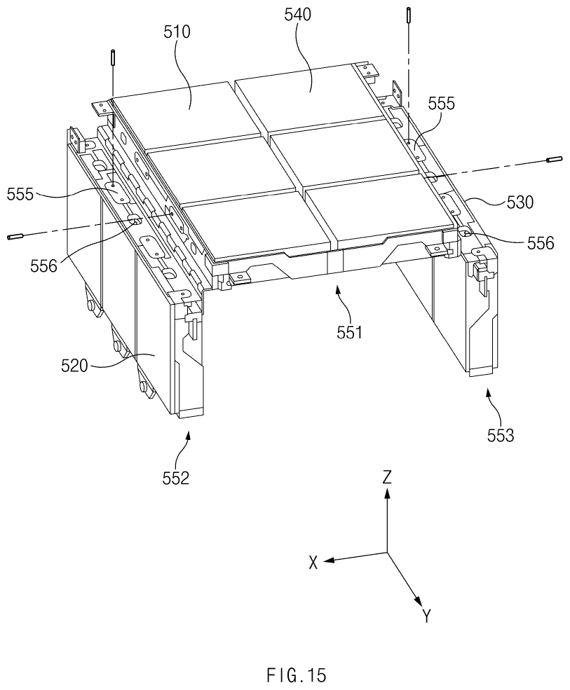

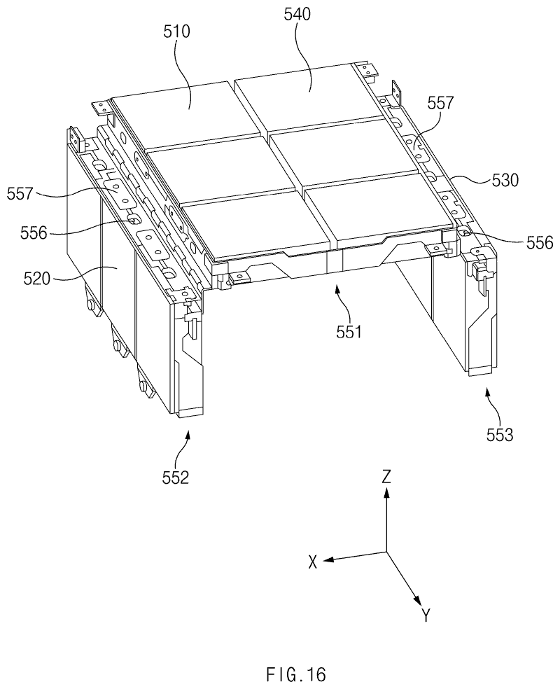

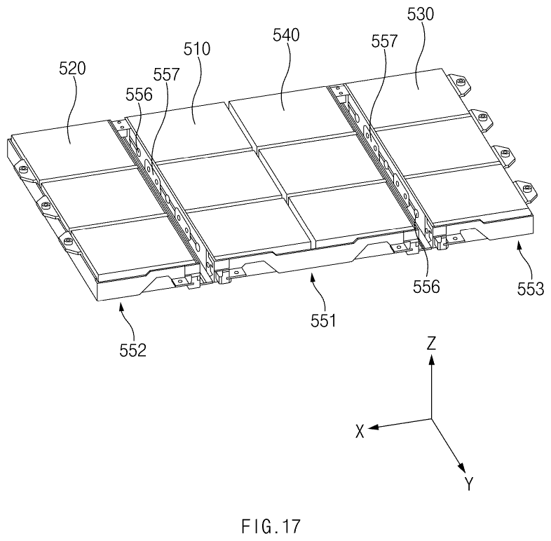

Hereinafter, embodiments of the present disclosure will be described in detail with reference to FIGS. 1 to 18. Hereinafter, a leftward/rightward direction may be a first direction, a forward/rearward direction may be a second direction, and an upward/downward direction may be a third direction.

FIG. 1 is an exploded perspective view of a battery pack according to an embodiment of the present disclosure.

Referring to FIG. 1, a battery pack 100 may include a battery housing 200, a plurality of cell stacks 300 that are mounted on the battery housing 200, and first and second pack covers 600 and 700.

The battery housing 200 may define an accommodation space 201, in which the plurality of cell stacks 300 are accommodated. The battery housing 200 may include a base plate 210 that contacts the plurality of cell stacks 300, and a crossing member 250 that contacts the base plate 210 and extends in a leftward/rightward direction (the “Y” direction or an opposite direction to the “Y” direction) to divide the accommodation space 201. Here, the leftward/rightward direction may be a first direction.

The crossing members 250 may be disposed to be spaced apart from each other along a forward/rearward direction (the “X” direction or an opposite direction to the “X” direction). Here, the forward/rearward direction may be a second direction. Crossing members 250 may be disposed on opposite sides of the base plate 210 in an upward/downward direction (the “Z” direction or an opposite direction to the “Z” direction), respectively. Here, the up/downward direction may be a third direction.

The battery housing 200 may include a front member 220 that covers a front (the “X” direction) area of the accommodation space 201, and a rear member 230 covering a rear area (an opposite direction to the “X” direction) of the accommodation space 201.

In some embodiments, the front member 220 and the rear member 230 may not be provided only on an upper side of the base plate 210, but may additionally be disposed in an upper area and a lower area of the base plate 210 in front and rear areas of the base plate 210.

The battery housing 200 may include a side member 240 that extends in the forward/rearward direction while connecting the front member 220 and the rear member 230, and covers a left or right area of the accommodation space 201. A pair of side members 240 may be provided, and may be provided on opposite sides of the accommodation space 201 in the leftward/rightward direction, respectively. Each of the pair of side members 240 may cover opposite side areas of the plurality of cell stacks 300 in the leftward/rightward direction.

The plurality of cell stacks 300 may be mounted in the accommodation space 201 to face each other in the forward/rearward direction with the crossing member 250 being interposed therebetween. The plurality of cell stacks 300 may be disposed such that the plurality of cells face each other toward the crossing member 250. Here, the cells of the plurality of cell stacks 300 may be angular battery cells, but are not limited thereto. Supporting frames 450 and 550 for supporting the plurality of cell stacks 300 may be provided in the plurality of cell stacks 300.

The plurality of cell stacks 300 may include a plurality of first cell stacks 400 that are disposed on an upper side of the base plate 210 and a plurality of second cell stacks 500 that are disposed on a lower side of the base plate 210.

The supporting frames 450 and 550 may include a first supporting frame 450 that supports a plurality of first cell stacks 400 and a second supporting frame 550 that supports a plurality of second cell stacks 500.

A first pack cover 600 may be disposed on an upper side of the plurality of first cell stacks 400 to cover an upper area of the plurality of first cell stacks 400. A second pack cover 700 may be disposed on a lower side of the plurality of second cell stacks 500 to cover a lower area of the plurality of second cell stacks 500.

Meanwhile, the battery housing 200 may further include a cross fixing member 270 that is disposed between the second pack cover 700 and the base plate 210. A plurality of cross fixing members 270 may extend in the leftward/rightward direction and may be spaced apart from each other in the forward/rearward direction. The cross fixing member 270 may be a member for fixing the plurality of first cell stacks 400 and the plurality of second cell stacks 500 together to the base plate 210.

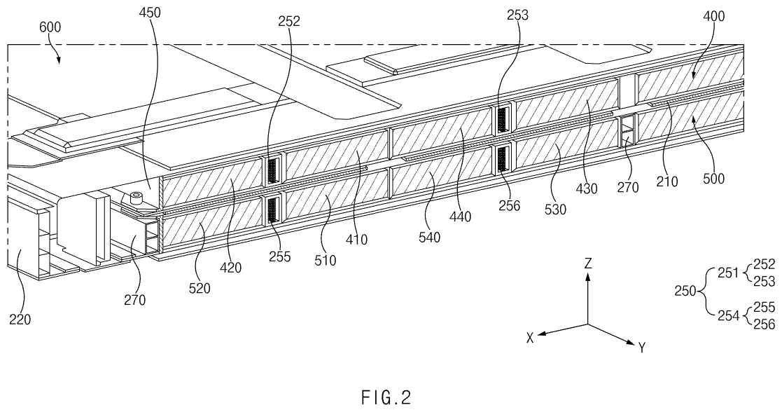

FIG. 2 is a vertical cross-sectional view of a battery pack according to an embodiment of the present disclosure.

Referring to FIG. 2, the crossing member 250 may include a first crossing member 251 that is disposed on an upper side of the base plate 210 and is disposed between the plurality of first cell stacks 400 and a second crossing member 254 that is disposed on a lower side of the base plate 210 and is disposed between the plurality of second cell stacks 500.

The first crossing member 251 may include a (1-1)-th crossing member 252 and a (1-2)-th crossing member 253 that is disposed on a rear side of the (1-1)-th crossing member 252. The (1-1)-th crossing member 252 and the (1-2)-th crossing member 253 may be spaced apart from each other in the forward/rearward direction. Here, the rear side may be one side in the second direction, and the front side may be an opposite side in the second direction.

The second crossing member 254 may include a (2-1)-th crossing member 255, and a (2-2)-th crossing member 256 that is disposed on the rear side of the (2-1)-th crossing member 255. The (2-1)-th crossing member 255 and the (2-2)-th crossing member 256 may be spaced apart from each other in the forward/rearward direction.

The plurality of first cell stacks 400 may include a (1-1)-th cell stack 410 that is disposed on a rear side of the (1-1)-th crossing member 252, a (1-2)-th cell stack 420 that is disposed on a front side of the (1-1)-th crossing member 252, a (1-3)-th cell stack 430 that is disposed on a rear side of the (1-2)-th crossing member 253, and a (1-4)-th cell stack 440 that is disposed on a front side of the (1-2)-th crossing member 253.

The plurality of second cell stacks 500 may include a (2-1)-th cell stack 510 that is disposed on a rear side of the (2-1)-th crossing member 255, a (2-2)-th cell stack 520 that is disposed on a front side of the (2-1)-th crossing member 255, a (2-3)-th cell stack 530 that is disposed on a rear side of the (2-2)-th crossing member 256, and a (2-4)-th cell stack 540 that is disposed on a front side of the (2-2)-th crossing member 256.

Then, the (1-2)-th cell stack 420 and the (2-2)-th cell stack 520 may be disposed between the front member 220 and the (1-1)-th crossing member 252, and between the front member 220 and the (2-1)-th crossing member 255, respectively.

Furthermore, the (1-1)-th cell stack 410 and the (1-4)-th cell stack 440 may be disposed between the (1-1)-th crossing member 252 and the (1-2)-th crossing member 253, and the (2-1)-th cell stack 510 and the (2-4)-th cell stack 540 may be disposed between the (2-1)-th crossing member 255 and the (2-2)-th crossing member 256.

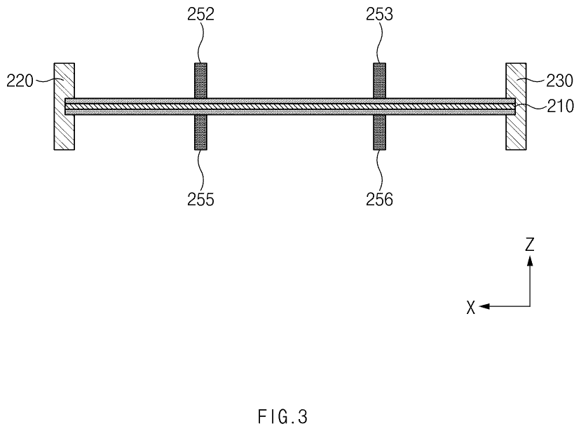

FIGS. 3 to 7 are schematic views sequentially illustrating a state, in which a first cell stack and a second cell stack are mounted on a battery housing according to an embodiment of the present disclosure.

Referring to FIGS. 3 to 7, a first cell stack 400 and a second cell stack 500 may be sequentially mounted in an interior of the accommodation space 201 (see FIG. 1). However, in FIGS. 3 to 7, it is illustrated that the first cell stack 400 and the second cell stack 500 are mounted between the front member 220 and the rear member 230, but the present disclosure is not limited thereto, and a plurality of first cell stacks 400 and a plurality of second cell stacks 500 may be inserted between the front member 220 and the rear member 230.

The front member 220, the rear member 230, and the (1-1)-th, (1-2)-th, (2-1)-th and (2-2)-th crossing members 252, 253, 255, and 256 may be mounted on the base plate 210. The base plate 210 may be coupled to the front member 220, the rear member 230, and the (1-1)-th, (1-2)-th, (2-1)-th, and (2-2)-th crossing members 252, 253, 255, and 256 to fix the front member 220, the rear member 230, and the (1-1)-th, (1-2)-th, (2-1)-th, and (2-2)-th crossing members 252, 253, 255, and 256.

The first cell stack 400 and the first supporting frame 450 may be mounted on an upper side of the base plate 210. The (1-1)-th crossing member 252 may be disposed between the (1-1)-th cell stack 410 and the (1-2)-th cell stack 420, and the (1-2)-th crossing member 253 may be disposed between the (1-3)-th cell stack 430 and the (1-4)-th cell stack 440.

Then, the lead parts 401 of the (1-1)-th cell stack 410 and the (1-2)-th cell stack 420 may be formed to protrude toward each other with the (1-1)-th crossing member 252 being interposed therebetween. Furthermore, the lead parts 401 of the (1-3)-th cell stack 430 and the (1-4)-th cell stack 440 may be formed to protrude toward each other with the (1-2)-th crossing member 253 being interposed therebetween.

At least a portion of the first supporting frame 450 may be provided between the plurality of first cell stacks 400 and the first crossing member 251. Then, an area that is provided between the plurality of first cell stacks 400 of the first supporting frame 450 and the first crossing member 251 may be a portion of a rotating area of the first supporting frame 450.

When the first cell stack 400 is mounted in the accommodation space 201 to contact the base plate 210, the second cell stack 500 may be mounted on a lower side of the base plate 210. The (2-1)-th crossing member 255 may be disposed between the (2-1)-th cell stack 510 and the (2-2)-th cell stack 520, and the (2-2)-th crossing member 256 may be disposed between the (2-3)-th cell stack 530 and the (2-4)-th cell stack 540.

Then, the lead parts 501 of the (2-1)-th cell stack 510 and the (2-2)-th cell stack 520 may be formed to protrude toward each other with the (2-1)-th crossing member 255 being interposed therebetween. Furthermore, the lead parts 501 of the (2-3)-th cell stack 530 and the (2-4)-th cell stack 540 may be formed to protrude toward each other with the (2-2)-th crossing member 256 being interposed therebetween.

At least a portion of the second supporting frame 550 may be provided between the plurality of second cell stacks 500 and the second crossing member 254. Then, an area that is provided between the plurality of second cell stacks 500 of the second supporting frame 550 and the second crossing member 254 may be a portion of a rotating area of the second supporting frame 550.

When the second cell stack 500 is disposed on a lower side of the base plate 210, a fixing member 810 for fixing the first supporting frame 450 and the second supporting frame 550 to the base plate 210 may be inserted into the first supporting frame 450, the base plate 210, and the second supporting frame 550.

As such, a battery pack 100 (see FIG. 1) may further include a fixing member 810 that is provided to fix the first supporting frame 450 and the second supporting frame 550 to the base plate 210.

In more detail, the first supporting frame 450 may include a first cell support area that supports the (1-2)-th cell stack 420 and the (1-3)-th cell stack 430 and a first fixing area that protrudes from the first cell support area in forward/rearward direction and contacts the base plate 210. Similarly, the second supporting frame 550 may include a second cell support area supporting the (2-2)-th cell stack 520 and the (2-3)-th cell stack 530 and a second fixing area that protrudes from the second cell support area in forward/rearward direction and contacts the base plate 210.

When the fixing member 810 is inserted into the first fixing area of the first supporting frame 450, the base plate 210, and the second fixing area of the second supporting frame 550, the cross fixing member 270 may be mounted on a lower side of the fixing area of the second supporting frame 550, and the second pack cover 700 may be mounted on a lower side of the cross fixing member 270.

In other words, the cross fixing member 270 may be mounted between the second pack cover 700 and the second supporting frame 550, and the cross fixing member 270 may be a component for supporting the second supporting frame 550.

The battery pack 100 may further include a frame fixing member 820 that is configured to fix the first supporting frame 450 and the second supporting frame 550 to the base plate 210 and is distinguished from the fixing member 810.

The cross fixing member 270 may be configured such that the frame fixing member 820 is inserted thereinto and that may be configured to support the second supporting frame 550.

When the cross fixing member 270 is mounted on a lower side of the second supporting frame 550, the frame fixing member 820 may be inserted into an area of the first supporting frame 450, which is spaced apart from an area, into which the fixing member 810 is inserted, in the leftward/rightward direction.

Then, the frame fixing member 820 may be inserted into a first fixing area of the first supporting frame 450, the base plate 210, a second fixing area of the second supporting frame 550, and the cross fixing member 270 to fix the cross fixing member 270 to the base plate 210. The frame fixing member 820 may be configured to have a length that is greater than the fixing member 810 in the upward/downward direction.

The battery pack 100 may further include a cover fixing member 830 for fixing the first pack cover 600 and the second pack cover 700 to the front member 220 and the end member 230.

When the frame fixing member 820 is inserted into the cross fixing member 270, the cover fixing member 830 may be inserted into the second pack cover 700, the front member 220, and the rear member 230 through the lower area of the second pack cover 700.

When the second pack cover 700 is coupled to the front member 220 and the rear member 230, the first pack cover 600 may be provided to be disposed on an upper side of the first cell stack 400. The cover fixing member 830 may be inserted into the first pack cover 600, the front member 220, and the rear member 230 through an upper area of the first pack cover 600.

When the cover fixing member 830 is inserted into the first pack cover 600, the front member 220, and the rear member 230, the first pack cover 600 and the second pack cover 700 may be coupled to the front member 220 and the rear member 230, respectively.

Meanwhile, the first pack cover 600 and the second pack cover 700 may include a cooling channel that is formed in an interior thereof and is configured to cool the first cell stack 400 or the second cell stack 500. Furthermore, the base plate 210 may include a cooling channel that is formed in an interior thereof and is configured to cool the first cell stack 400 and the second cell stack 500.

According to this structure, because the base plate 210, in which the cooling channel is formed, is provided between the first cell stack 400 and the second cell stack 500, a thermal transfer between the first cell stack 400 and the second cell stack 500 may be delayed. In other words, heat transfer from any one of the first cell stack 400 and the second cell stack 500 to the other may be prevented, and thus, thermal runaway of the first cell stack 400 or the second cell stack 500 may be prevented.

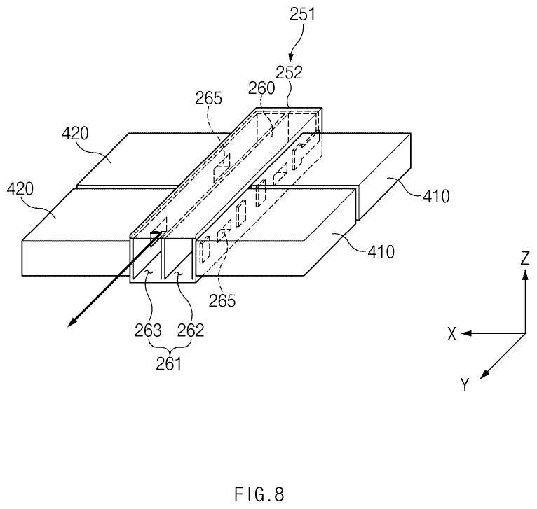

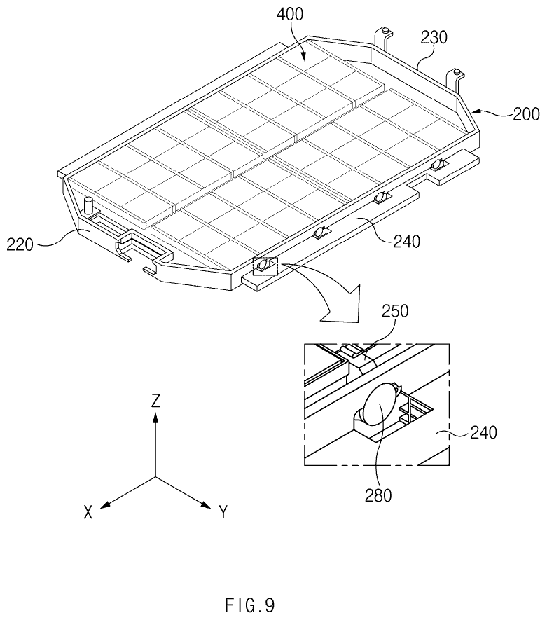

FIG. 8 is a schematic view illustrating a flame or gas that flows through a venting passage when a fire occurs in cell stacks that face each other with a crossing member being interposed therebetween according to an embodiment of the present disclosure. FIG. 9 is an enlarged view of a venting device that is mounted on a battery housing according to an embodiment of the present disclosure.

Referring to FIGS. 8 and 9, a (1-1)-th crossing member 252 may be provided between the (1-1)-th cell stack 410 and the (1-2)-th cell stack 420. The (1-1)-th crossing member 252 may include a venting passage 261 that extends in the leftward/rightward direction (the first direction) between the (1-1)-th cell stack 410 and the (1-2)-th cell stack 420, and is communicated with the (1-1)-th cell stack 410 and the (1-2)-th cell stack 420, respectively.

The crossing member 252 may include a partition wall 260 that extends in the upward/downward direction to divide the venting passage 261 in the forward/rearward directions in an interior of the (1-1)-th crossing member 252. The partition wall 260 may extend in the leftward/rightward direction along the venting passage 261.

The venting passage 261 may include a first venting area 262 that is formed on a front side of the partition wall 260, and a second venting area 263 that is formed on a rear side of the partition wall 260. The first venting area 262 and the second venting area 263 may be partitioned from each other by the partition wall 260. The partition wall 260 may be formed of steel or mica to prevent heat transfer between fluids that flow through the first venting area 262 and the second venting area 263, respectively. Furthermore, the remaining area of the (1-1)-th crossing member 252 may be formed of aluminum (Al).

The first venting area 262 that is formed in an interior of the crossing member 252 may be communicated with the (1-1)-th cell stack 410. The second venting area 263 that is formed in an interior of the (1-1)-th crossing member 252 may be communicated with the (1-2)-th cell stack 420.

To achieve this, the (1-1)-th crossing member 252 may include a venting hole 265 that is configured such that a flame or high-temperature gas generated from the (1-1)-th cell stack 410 or the (1-2)-th cell stack 420 flows into the first venting area 262 or the second venting area 263. The venting holes 265 may be disposed on opposite sides of the forward/rearward direction of the (1-1)-th crossing member 252, respectively, and may be disposed to be spaced apart from each other in the leftward/rightward direction.

Venting devices 280 may be provided at opposite ends of the first venting area 262 and the second venting area 263 in the leftward/rightward direction. The venting devices 280 may be mounted on the side members 240. Eight venting devices 280 may be provided, and four venting devices 280 may be provided on each of opposite sides of the battery housing 200 (see FIG. 1) in the leftward/rightward direction, but the present disclosure is not limited thereto. The venting devices 280 may be formed to be communicated with venting passages 261 of the two crossing members 250 disposed in an upward/downward direction with the base plate 210 being interposed therebetween.

The venting devices 280 may prevent external materials from flowing into the battery housing 200 when the cells of the cell stack 300 operate normally. However, when a fire occurs in the cell, the venting device 280 may be provided to communicate the venting passage 261 and an outside of the battery housing 200 due to a flame that flows through the venting passage 261 or a high-temperature gas pressure.

A description of the (1-1)-th cell stack 410, the (1-2)-th cell stack 420, and the (1-1)-th crossing member 252 illustrated in FIGS. 8 and 9 may be used as a description of the (1-3)-th cell stack 430, the (1-4)-th cell stack 440, and the (1-2)-th crossing member 253.

Furthermore, a description of the (1-1)-th cell stack 410, the (1-2)-th cell stack 420, and the (1-1)-th crossing member 252 may be used as a description of the (2-1)-th cell stack 510, the (2-2)-th cell stack 520, and the (2-1)-th crossing member 255, and a description of the (2-3)-th cell stack 530, the (2-4)-th cell stack 540, and the (2-2)-th crossing member 256.

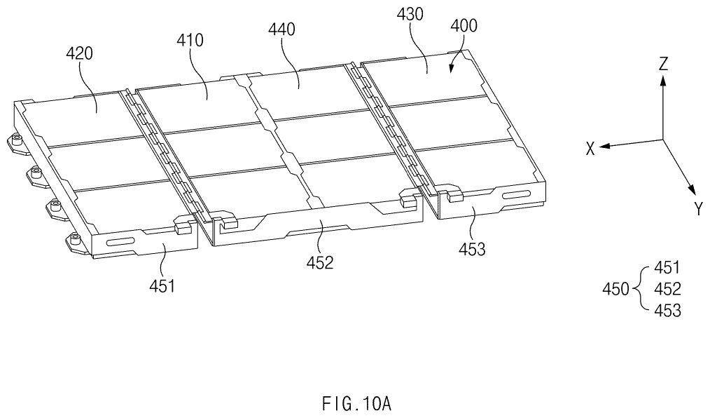

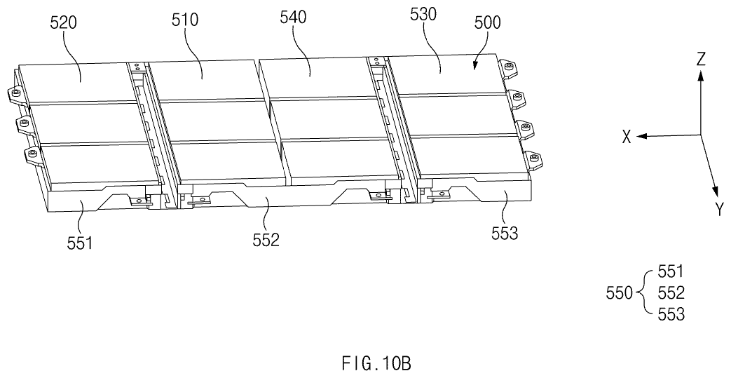

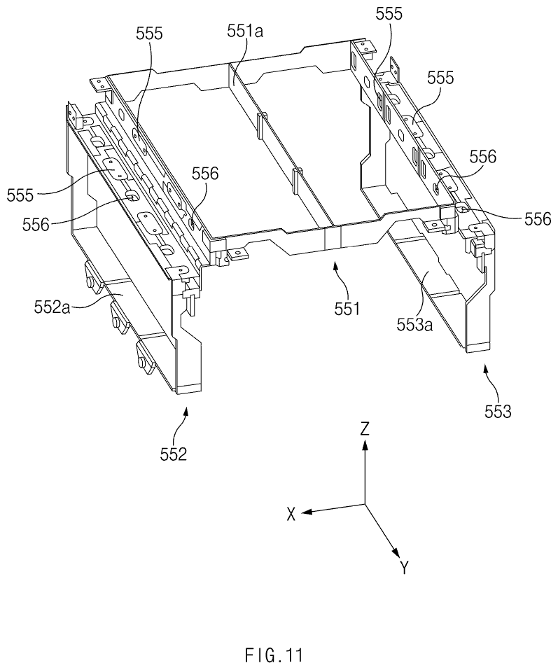

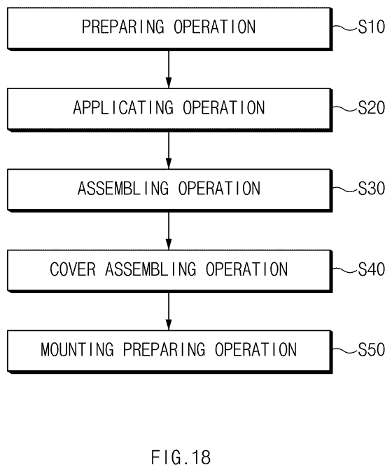

FIG. 10A is a perspective view of a first cell stack that is mounted on a first supporting frame according to an embodiment of the present disclosure. FIG. 10B is a perspective view of a second cell stack that is mounted on a second supporting frame according to an embodiment of the present disclosure. FIGS. 11 to 17 are perspective views sequentially illustrating a process of manufacturing a second cell stack according to an embodiment of the present disclosure. FIG. 18 is a flowchart of a method for manufacturing a cell stack according to an embodiment of the present disclosure.

Referring to FIGS. 10A and 10B, a first cell stack 400 may be supported by a first supporting frame 450. The second cell stack 500 may be supported by a second supporting frame 550.

The first supporting frame 450 may include a (1-1)-th supporting frame area 451 that is configured to support the (1-1)-th cell stack 410 and the (1-4)-th cell stack 440 together, a (1-2)-th supporting frame area 452 that is configured to support the (1-2)-th cell stack 420, and a (1-3)-th supporting frame area 453 that is configured to support the (1-3)-th cell stack 430.

The second supporting frame 550 may include a (2-1)-th supporting frame area 551 that is configured to support the (2-1)-th cell stack 510 and the (2-4)-th cell stack 540 together, a (2-2)-th supporting frame area 552 that is configured to support the (2-2)-th cell stack 520, and a (2-3)-th supporting frame area 553 that is configured to support the (2-3)-th cell stack 530.

The first and second supporting frames 450 and 550 may be configured such that a portion thereof is rotatable with respect to another portion thereof. The (1-1)-th supporting frame area 451 and the (1-2)-th supporting frame area 452 may be coupled to each other to be rotatable, and the (1-1)-th supporting frame area 451 and the (1-3)-th supporting frame area 453 may be coupled to each other to be rotatable.

In more detail, the (1-2)-th supporting frame area 452 may be coupled to be rotatable about a central axis that extends in the first direction from the (1-1)-th supporting frame area 451. Furthermore, the (1-3)-th supporting frame area 453 may be coupled to be rotatable about the central axis that extends in the first direction from the (1-1)-th supporting frame area 451.

The first supporting frame 450 may be switched between a folding state, in which the (1-2)-th supporting frame area 452 and the (1-3)-th supporting frame area 453 have a specific angle from the (1-1)-th supporting frame area 451, and an unfolding state, in which the (1-2)-th supporting frame area 452 and the (1-3)-th supporting frame area 453 are unfolded from the (1-1)-th supporting frame area 451. When the folding state of the first supporting frame 450 is switched to the unfolding state, a rotation direction of the (1-2)-th supporting frame area 452 and a rotation direction of the (1-3)-th supporting frame area 453 may be opposite to each other.

In relation to the switching structure of the first supporting frame 450, a description of the second supporting frame 550 is replaced with a description of the first supporting frame 450, except that it is symmetrical to the first supporting frame 450 in the upward/downward direction.

Hereinafter, the operations of assembling the (2-1)-th to (2-4)-th cell stacks 510, 520, 530, and 540 in the second supporting frame 550 will be described sequentially with reference to FIGS. 11 to 18. A description of the order, in which the (1-1)-th to (1-4)-th cell stacks 410, 420, 430, and 440 are assembled in the first supporting frame 450, is replaced with a description of a structure, in which the (2-1)-th to (2-4)-th cell stacks 510, 520, 530, and 540 are assembled in the second supporting frame 550.

Before the (2-1)-th to (2-4)-th cell stacks 510, 520, 530, and 540 are assembled in the supporting frame 550, the second supporting frame 550 may be provided in a preparing operation S10 in a folding state. The preparing operation S10 may be an operation of preparing the first and second supporting frames 450 and 550 that are rotatable about the central axis, at least a portion of which extends in the first direction.

In other words, the (2-2)-th supporting frame area 552 and the (2-3)-th supporting frame area 553 may be disposed to have a specific angle from the (2-1)-th supporting frame area 551.

The supporting frame 550 may include a hinge area 554 that is provided an area, in which the (2-2)-th supporting frame area 552 and the (2-1)-th supporting frame area 551 are coupled to each other or an area, in which the (2-3)-th supporting frame area 553 and the (2-1)-th supporting frame area 551 are coupled to each other. The (2-2)-th supporting frame area 552 and the (2-3)-th supporting frame area 553 may be coupled to the (2-1)-th supporting frame area 551 to be rotatable through the hinge area 554.

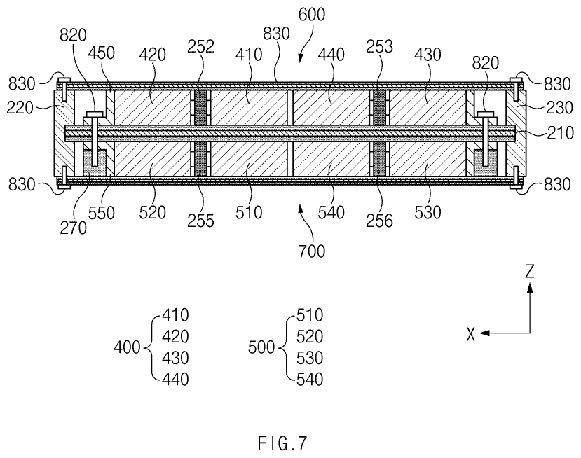

The hinge area 554 of the supporting frame 550 may be a portion, at which the (2-1)-th crossing member 255 (see FIG. 7) or the (2-2)-th crossing member 256 is provided. Furthermore, the hinge area 554 of the second supporting frame 550 may be a portion, from which the lead parts 501 of the plurality of second cell stacks 500 protrude.

The second supporting frame 550 may include a busbar 555 that is electrically connected to a lead part 501 of the second cell stack 500, and a communication hole 556 that communicates the venting passage 261 provided in an interior of the second crossing member 254 (see FIG. 2) and the second cell stack 500. The communication hole 556 may be spaced apart from the busbar 555 in the leftward/rightward direction. The communication hole 556 may be provided in an area of the second supporting frame 550 that is provided between the plurality of second cell stacks 500 and the second crossing member 254.

A plurality of busbars 555 may be configured to connect the lead parts 501 of two cells of the second cell stack 500, which are spaced apart from each other in the leftward/rightward direction, respectively. Furthermore, a plurality of communication holes 556 may be provided to correspond to the cells of the second cell stack 500, which are arranged in the leftward/rightward direction.

An area, in which the busbar 555 and the lead part 501 of the second cell stack 500 are connected to each other, may be provided adjacent to the hinge area 554, an area, in which the busbar 555 and the lead part 501 of the second cell stack 500 are connected to each other, may be alternately disposed in the leftward/rightward direction.

A description of the structure of the second supporting frame 550 is also used in a description of the first supporting frame 450. The venting hole 265 of the first crossing member 251 illustrated in FIG. 8 may be formed on an area that faces the communication hole of the first supporting frame 450. Similarly, the venting hole of the second crossing member 254 (see FIG. 7) may be formed on an area that faces the communication hole 456 of the second supporting frame 550.

When the preparing operation S10 is completed, an applicating operation S20 may be performed on the second supporting frame 550. The applicating operation S20 may be an operation of applying an adhesive to one surface of the second supporting frame 550 to fix the second cell stack 500 in a folding state of the second supporting frame 550.

The (2-2)-th and (2-3)-th supporting frame areas 552 and 553 may include one surface 552a and 553a that is provided on an opposite side that is opposite to one side, on which the hinge area 554 is provided. Furthermore, the (2-1)-th supporting frame area 551 may include one surface 551a that is disposed between a pair of hinge areas 554 that are provided in the forward/rearward direction.

The applicating operation S20 may be an operation of applying an adhesive to one surfaces 552a and 553a of the (2-2)-th and (2-3)-th supporting frame areas 552 and 553, and applying the adhesive to one surface 551a of the (2-1)-th supporting frame area 551.

When the adhesive is applied to the surfaces 552a and 553a of the (2-2)-th and (2-3)-th supporting frame areas 552 and 553, adhesion surfaces 552b and 553b that are provided on an opposite side that is opposite to the one side, on which the second crossing members 254 of the (2-2)-th and (2-3)-th cell stacks 520 are provided, and for fixing the (2-2)-th cell stack 530 may be provided on the surfaces 552a and 553a of the (2-2)-th and (2-3)-th supporting frame areas 552 and 553.

Furthermore, when an adhesive is applied to one surface 551a of the (2-1)-th supporting frame area 551, an adhesion surface 551b that is disposed between the (2-1)-th cell stack 510 and the (2-4)-th cell stack 540, and for fixing the (2-1)-th cell stack 510 and the (2-4)-th cell stack 540 may be provided on one surface 551a of the (2-1)-th supporting frame area 551. The adhesion surface 551b of the (2-1)-th supporting frame area 551 may include both a surface that faces a front side and a surface that faces a rear side.

When the applicating operation S20 is completed, an assembling operation S30 of assembling the (2-1)-th to (2-4)-th cell stacks 510, 520, 530, and 540 in the second supporting frame 550 may be performed.

In the assembling operation S30, in the folding state of the second supporting frame 550, the lead parts 501 of the (2-1)-th to (2-4)-th cell stacks 510, 520, 530, and 540 are inserted into the second supporting frame 550 to face the hinge area 554, and the (2-1)-th to (2-4)-th cell stacks 510, 520, 530, and 540 are adhered to the adhesion surfaces 551b, 552b, and 553b, respectively.

In the assembling operation S30, when the (2-1)-th to (2-4)-th cell stacks 510, 520, 530, and 540 are adhered to the adhesion surfaces 551b, 552b, and 553b, respectively, the lead parts 501 of the (2-1)-th to (2-4)-th cell stacks 510, 520, 530, and 540 and the busbar 555 may be welded in an area that is adjacent to the central axis. Then, welding may be performed by using a laser.

When the assembling operation S30 is completed, a cover assembling operation S40 may be performed on the second supporting frame 550 and the second cell stack 500. The cover assembling operation S40 may be an operation of assembling the busbar cover 557 on an opposite side to one side, on which it is connected to the lead part 501 of the busbar 555. As such, the second supporting frame 550 may include a busbar cover 557 that is formed of an electrically insulating material.

When the cover assembling operation S40 is completed, a mounting preparing operation S50 of switching to an unfolding state to unfold the second supporting frame 550 by rotating the (2-1)-th to (2-3)-th supporting frame areas 551, 552, and 553 about the central axis may be performed.

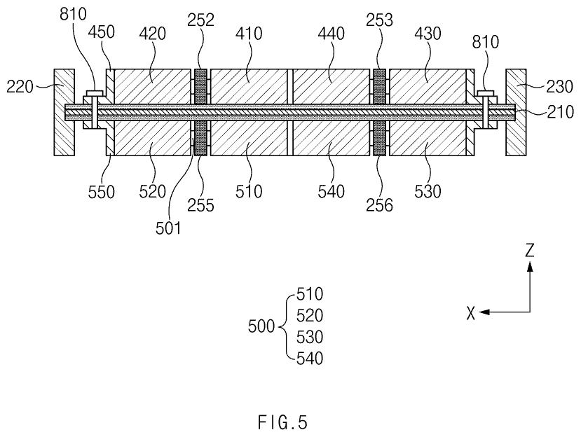

When the mounting preparing operation S50 is completed, as illustrated in FIG. 5, the second supporting frame 550 may be mounted in an interior of the accommodation space 201 (see FIG. 1). Thereafter, in the first and second cell stacks 400 and 500 according to the present disclosure, the assembly of the battery pack 100 may be completed through the above-described processes of FIGS. 3 to 7.

According to the above-described structure, even in a structure, in which the cell stack 300 is mounted in the form of a CTP in an interior of the battery pack 100, at least a portion thereof may be rotated so that the first and second supporting frames 450 and 550 are switched between the folding state and the unfolding state, so that the lead parts 401 and 501 of the first and second cell stacks 400 and 500 and the busbar 555 may be welded relatively easily. Accordingly, the manufacturing efficiency of the battery pack 100 may be improved.

Furthermore, the safety of the battery pack 100 may be improved as the thermal runaway of the battery pack 100 is prevented while the heat transfer between the first and second cell stacks 400 and 500 is delayed and the flame or the high-temperature gas is vent to the outside of the battery housing 200 while being prevented from flowing to the adjacent cell under a structure, in which the lead parts 401 and 501 of the first and second cell stacks 400 and 500 are disposed to protrude toward the crossing member 250.

The present technology may improve the manufacturing efficiency of the cell stack because a portion of the supporting frame may be rotated with respect to another portion thereof so that the lead part of the cell stack and the busbar may be easily coupled to each other.

In addition, various effects that are directly or indirectly identified through the document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a battery housing defining an accommodation space, and including a crossing member extending in a first direction to divide the accommodation space;
a plurality of cell stacks mounted in the accommodation space to face each other in a second direction crossing the first direction with the crossing member being interposed therebetween; and
a supporting frame supporting the plurality of cell stacks, and configured such that a portion of the supporting frame is rotatable with respect to another portion of the supporting frame,
wherein the crossing member includes a venting passage extending in the first direction between the plurality of cell stacks, and communicated with each of the plurality of cell stacks.

2. The battery pack of claim 1, wherein each of the plurality of cell stacks includes a lead part protruding toward the crossing member, and
wherein the supporting frame includes a busbar electrically connected to the lead part, and a communication hole spaced apart from the busbar in the first direction while communicating the venting passage and the cell stack.

3. The battery pack of claim 2, wherein an area, in which the busbar and the lead part are connected to each other, and the communication hole are alternately disposed along the first direction.

4. The battery pack of claim 2, wherein the crossing member includes a venting hole formed in an area facing the communication hole.

5. The battery pack of claim 1, wherein the battery housing further includes a base plate contacting the crossing member,
wherein the plurality of cell stacks include:
a plurality of first cell stacks disposed on one side of the base plate in a third direction crossing the first direction and the second direction; and
a plurality of second cell stacks disposed on an opposite side of the base plate in the third direction, and
wherein the supporting frame includes a first supporting frame configured to support the plurality of first cell stacks, and a second supporting frame configured to support the plurality of second cell stacks.

6. The battery pack of claim 5, wherein the plurality of first cell stacks include:
a (1-1)-th cell stack mounted on one side of the crossing member in the second direction, in the accommodation space; and
a (1-2)-th cell stack mounted on an opposite side of the crossing member in the second direction, in the accommodation space, and
wherein the first supporting frame includes:
a (1-1)-th supporting frame area supporting the (1-1)-th cell stack; and
a (1-2)-th supporting frame area supporting the (1-2)-th cell stack.

7. The battery pack of claim 6, wherein the (1-1)-th supporting frame area and the (1-2)-th supporting frame area are coupled to each other to be rotatable with respect to each other.

8. The battery pack of claim 6, wherein each of the (1-1)-th supporting frame area and the (1-2)-th supporting frame area includes:
an adhesion surface provided on an opposite side to one side, on which the crossing member of the (1-1)-th cell stack or the (1-2)-th cell stack is provided, and configured to fix the (1-1)-th cell stack or the (1-2)-th cell stack.

9. The battery pack of claim 2, wherein the supporting frame further includes a busbar cover configured to cover an opposite side to one side of the busbar, which is connected to the lead part.

10. The battery pack of claim 9, wherein the busbar cover is formed of an electrically insulating material.

11. The battery pack of claim 5, wherein the crossing member includes a first crossing member disposed on the base plate in the third direction, and a second crossing member disposed on an opposite side of the base plate in the third direction,
wherein the first crossing member includes a (1-1)-th crossing member, and a (1-2)-th crossing member spaced apart from the (1-1)-th crossing member in the second direction,
wherein the plurality of first cell stacks include a (1-1)-th cell stack disposed on the one side of the (1-1)-th crossing member in the second direction, a (1-2)-th cell stack disposed on the opposite side of the (1-1)-th crossing member in the second direction, a (1-3)-th cell stack disposed on the one side of the (1-2)-th crossing member in the second direction, and a (1-4)-th cell stack disposed on the opposite side of the (1-2)-th crossing member in the second direction, and
wherein the first supporting frame includes a (1-1)-th supporting frame area supporting the (1-1)-th cell stack and the (1-4)-th cell stack together, a (1-2)-th supporting frame area supporting the (1-2)-th cell stack, and a (1-3)-th supporting frame area supporting the (1-3)-th cell stack.

12. The battery pack of claim 11, wherein each of the (1-2)-th supporting frame area and the (1-3)-th supporting frame area is coupled to be rotatable from the (1-1)-th supporting frame area.

13. The battery pack of claim 11, wherein each of the (1-2)-th supporting frame area and the (1-3)-th supporting frame area includes:
an adhesion surface provided on an opposite side to one side, on which the crossing member of the (1-2)-th cell stack or the (1-3)-th cell stack is provided, and configured to fix the (1-2)-th cell stack or the (1-3)-th cell stack.

14. The battery pack of claim 11, wherein the (1-1)-th supporting frame area includes:
an adhesion surface disposed between the (1-1)-th cell stack and the (1-4)-th cell stack, and configured to fix the (1-1)-th cell stack or the (1-4)-th cell stack.

15. A method for manufacturing a cell stack, the method comprising:
a preparing operation of preparing a supporting frame, at least a portion of which is rotatable about a central axis extending in a first direction;
an applicating operation of applying an adhesive on one surface of the supporting frame to fix a cell stack to the one surface; and
an assembling operation of assembling the cell stack in the supporting frame.

16. The method of claim 15, wherein the cell stack includes a first cell stack and a second cell stack,
wherein the first cell stack includes a (1-1)-th cell stack, and a (1-2)-th cell stack spaced apart from the (1-1)-th cell stack in a horizontal direction,
wherein the supporting frame includes a first supporting frame and a second supporting frame,
wherein the first supporting frame include a (1-1)-th supporting frame area supporting the (1-1)-th cell stack, and a (1-2)-th supporting frame area supporting the (1-2)-th cell stack, and
wherein the (1-1)-th supporting frame area and the (1-2)-th supporting frame area are coupled to each other to be rotatable about the central axis.

17. The method of claim 16, wherein the assembling operation includes:
welding a lead part of the (1-1)-th cell stack or the (1-2)-th cell stack and a busbar in an area being adjacent to the central axis in a state, in which the (1-1)-th supporting frame area and the (1-2)-th supporting frame area are rotated to have a specific angle.

18. The method of claim 17, further comprising:
a cover assembling operation of assembling a busbar cover on an opposite side to one side of the busbar, which is connected to the lead part.

19. The method of claim 18, further comprising:
a mounting preparing operation of unfolding the supporting frame by rotating the (1-1)-th supporting frame area and the (1-2)-th supporting frame area about the central axis, after the cover assembling operation.
